(19) United States
(12) Patent Application Publication
(10) Pub. No.: US 2002/0147673 A1
(43) Pub. Date: Oct. 10, 2002

(54) Transaction status messaging

(75) Inventors: Robert E. Allen, Austin, TX (US); David Howard Fischer, Georgetown, TX (US); Jacob Marvin Rzepka, Round Rock, TX (US); William K. Wittenbrook, Austin, TX (US)

Correspondence Address: Robert V. Wilder, 4235 Kingsburg Drive, Round Rock, TX, 78681, US

(73) Assignee: International Business Machines Corporation, Armonk, NY (US)

(21) Appl. No.: 09/773,190

(22) Filed: Jan. 31, 2001

(51) Int. Cl. G06F 17/60

(52) U.S. Cl. 705/37; 340/540

(57) ABSTRACT

A method and implementing system is provided in which a client is able to initiate an ongoing electronic transaction between a communication device and a network site. A separate port is established for the subsequent direct transmission of transaction status messages from the network site back to the user device. The client is enabled to customize a signaling system at the user terminal to designate various signals to correspond to different kinds of the transaction status messages such that the client is signaled directly when a transaction status change occurs with respect to the electronic transaction initiated by the client. In an example, a client is enabled to log on to an auction web site server and enter a bid on an auctioned item. When the entered bid is no longer winning, an appropriate message is sent to the client through the separate port.

### FIELD OF THE INVENTION

The present invention relates generally to information processing systems and more particularly to a methodology and implementation for prompt status messaging between systems regarding pending electronic transactions.

### BACKGROUND OF THE INVENTION

In recent years, an increase in the acceptability and use of various kinds of equipment to access the World Wide Web (the web) has resulted in a rapid expansion of the kinds of services which are being made available on the web. Currently, the many websites are accessible not only with personal computers but also with wireless phones, wireless palm-sized devices and so-called Personal Digital Assistant or PDA devices. This ever-increasing use of the web, and the relative ease with which access to the web can be accomplished, will continue to drive the opening of new websites and new services available on the websites.

One rapidly expanding area on the web is the capability to accomplish complete electronic purchasing transactions and other transactions while “on-line”. Such purchasing applications provide the ability for potential buyers to become informed about items and to complete an electronic transaction by actually ordering one or more items, and authorizing payment for the ordered items in one “on-line” session, using any of the website-accessing devices described above.

In accomplishing electronic transactions on the web, there are several areas where improvements are needed. One such area is the manner in which notification of certain aspects of the sale are communicated to the purchaser of an item. In most applications, a purchaser or client will “log-on” to a website that has various items available for sale. The purchaser can then view the items, identify the item to be purchased, and enter information regarding the specific details of the purchase, i.e. the number of units, color, price, etc. The purchaser will also enter information concerning the method of payment and authorization to charge the purchase against a particular charge account identified by the purchaser, and then disconnect from the website. The purchaser may not know if and when the authorized charge has been approved by the designated creditor until the ordered item arrives. In some cases, the purchaser may get a confirmation of the order from the website but even in that case, the confirmation is in the form of an “email”. This practice presents a problem to many purchasers who do not regularly check their incoming email. Further, the email typically will indicate a time period during which delivery of the item may be expected, such as “between 2-4 weeks”. In many cases, a purchaser will desire to receive the delivery information in a more timely manner.

Other aspects of on-line purchases and other on-line electronic transactions should also be communicated to purchasers in a more timely manner. For example, an increasingly popular way to purchase items on-line is through an on-line “auction” process. There are many formats available for the implementation of an on-line auction but in any format, the timeliness of transactional information related to a purchase bid, relative to other bids, is extremely critical. Nevertheless, bidders are currently informed that their bid is successful or not successful only by means of an email which may not arrive until the bidding process has completed and it is no longer possible for a purchaser to increase his or her bid.

Thus, there is a need for an improved method and apparatus which may be used to more quickly make a user aware of developing selected aspects of pending electronic transactions.

### SUMMARY OF THE INVENTION

A method and implementing system is provided in which a client is able to initiate an ongoing electronic transaction between a communication device and a network site. A separate port is established for the subsequent direct transmission of transaction status messages from the network site back to the user device. The client is enabled to customize a signaling system at the user terminal to designate various signals to correspond to different kinds of the transaction status messages such that the client is signaled directly when a transaction status change occurs with respect to the electronic transaction initiated by the client.

### BRIEF DESCRIPTION OF THE DRAWINGS

A better understanding of the present invention can be obtained when the following detailed description of a preferred embodiment is considered in conjunction with the following drawings, in which:

FIG. 1 is a diagram of a computer system in which the present invention may be implemented;

FIG. 2 is a simplified schematic diagram showing selected components and subsystems of the computer system illustrated in FIG. 1;

FIG. 3 is an illustration of a computer system display screen useful in explaining an exemplary operation of the present invention;

FIG. 4 is an illustration showing several possible communication paths for messages between a server and a client terminal;

FIG. 5 is flow chart illustrating a high level operational sequence utilized in connection with the present invention;

FIG. 6 is a flow chart illustrating an exemplary operational sequence occurring at a server site in the exemplary embodiment; and

FIG. 7 is a flow chart illustrating an exemplary operational sequence occurring at a client or user device in the exemplary embodiment.

### DETAILED DESCRIPTION

The various methods discussed herein may be implemented within a typical computer system which may include a workstation or personal computer, as well as various kinds of other communications devices such as palm devices, PDA (personal digital assistant) devices and wireless devices. The term “user terminal” as used herein is intended to include any and all such devices and other devices which are able to establish a communication link with a network site as hereinafter explained. In an illustrated example, an implementing system includes one or more processors in a multi-bus computer-based system which may be coupled into a network of similar systems. However, since the workstation or computer system implementing the present invention in an exemplary embodiment, is generally known in the art and composed of electronic components and circuits which are also generally known to those skilled in the art, circuit details beyond those shown in the drawings are not specified to any greater extent than that considered necessary as illustrated, for the understanding and appreciation of the underlying concepts of the present invention and in order not to obfuscate or distract from the teachings of the present invention.

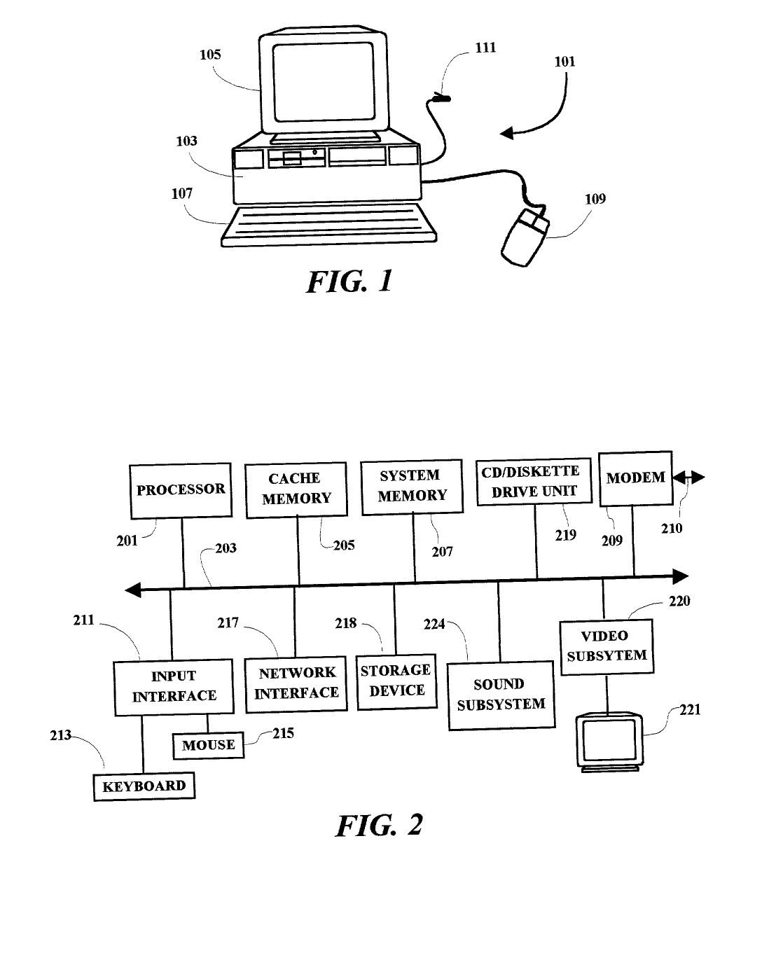

In FIG. 1, an exemplary client terminal computer system 101 includes an electronics enclosure 103 which is typically arranged for housing one or more CPUs (central processing units) along with other component devices and subsystems of the computer system 101. The computer system 101 also includes a monitor or display unit 105, a keyboard 107 and a mouse or pointing device 109, which are all interconnected within the illustrated computer system. Also shown is a connector 111 which is arranged for connecting a modem or other network connection within the computer system to a communication line such as a telephone line in the present example. The present invention may also be implemented in a wireless system without the connector 111 or hard-wired through a digital cable.

Several of the major components of the exemplary system 101 are illustrated in FIG. 2. A processor circuit 201 is connected to a system bus 203 which may be any host system bus. It is noted that the processing methodology disclosed herein will apply to many different bus and/or network configurations. A cache memory device 205, and a system memory unit 207 are also connected to the bus 203. A modem 209 is arranged for connection 210 to a communication line, such as a telephone line, through a connector 111 (FIG. 1). The modem 209, in the present example, selectively enables the computer system 101 to establish a communication link and initiate communication with another computer system, or network or database server. Such a communication link may also be established by other client devices including wireless devices.

The system bus 203 is also connected through an input interface circuit 211 to a keyboard 213 and a mouse or pointing device 215 in the illustrated example. Other input means may also be used in other devices such as menu-driven limited key inputs designed for small screen wireless devices. The bus 203 in the example is also coupled to a separate network subsystem interface 217 and a CD/diskette drive unit 219. A sound producing subsystem 224 is connected to the system bus 203, and a video subsystem 220, which may include a graphics subsystem, is connected to a display device 221. The sound subsystem may be one of several generally available systems which respond to an input digital signal to provide various output sounds and/or sound bytes containing predetermined messages. A storage device 218, which may comprise a hard drive unit or CD ROM, is also coupled to the bus 203. The CD/diskette drive unit 219 provides a means by which individual diskette programs may be loaded on to the hard drive, or accessed directly, for selective execution by the computer system 101. As is well known, program diskettes containing application programs represented by magnetic indicia on the diskette, or programs in system memory, or acquired through a local network or through the World Wide Web may be read to provide program signals. Such program signals are selectively effective to cause the computer system to present displays on the screen of a display device and respond to user inputs in accordance with the functional flow of the application program being executed.

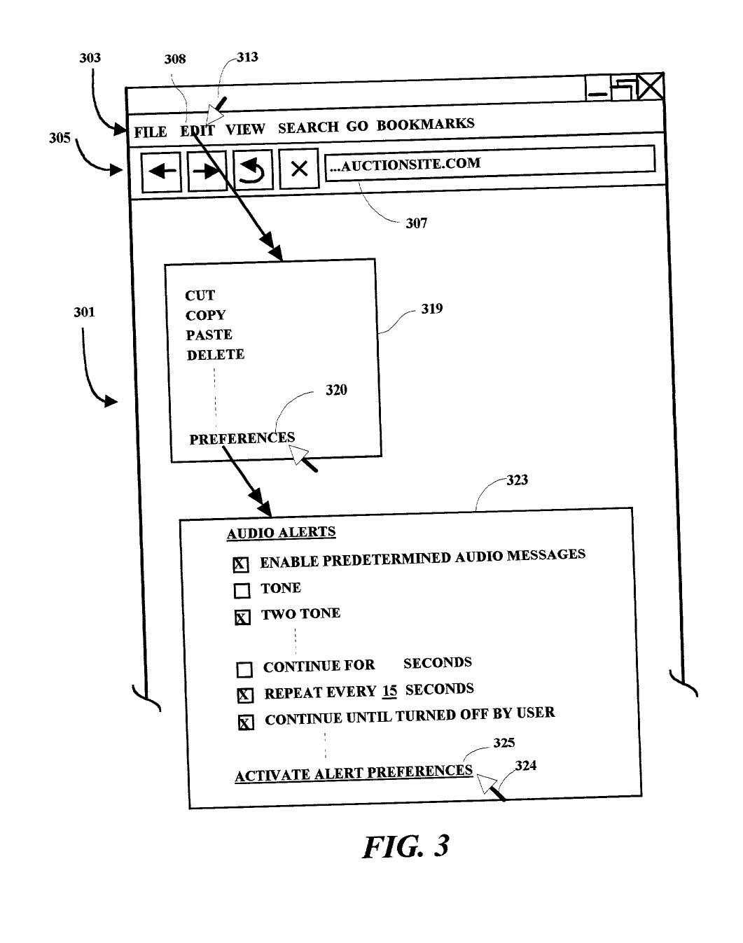

FIG. 3 illustrates an exemplary implementation of an audio customization feature of the present invention. In the example, the audio customization user interface is included within a browser program but it is understood that the user interface may also be part of a stand alone application. As shown, a display device running a browser application presents a screen 301 in a well known format including various functions 303 and operations 305 which may be selected by a user or client. The format also includes a site address block 307 which contains the address of a site (e.g. “AUCTIONSITE.COM”) to which the user is or wishes to be connected. In the example, when a user moves a pointer indicium 313 and points to and clicks on the “EDIT” function 308 using the pointer control device, an “EDIT” window 319 is presented. The user/client is then able to point and click on a “PREFERENCES” icon 320 and an “AUDIO ALERTS” window 323 is presented. In the AUDIO screen 323 a client/user is able to customize the audio signals which will be produced by the sound subsystem 224 (FIG. 2). A user, for example, may select an option to enable predetermined audio messages in combination with a two tone leader signal as illustrated. The duration, repetition and termination mode of the audio signals may also be set as illustrated. After a client/user has made the choices to customize the alert messages, the user is then able to move the pointer 324 to point and click on an activation icon 325 which is effective to enter the selected inputs. Thereafter, when an incoming message is detected (as hereinafter explained), the selected alert scheme, which may include an audio voice message, will be executed.

As hereinbefore noted, the present invention facilitates and improves the execution of electronic transactions which are initiated between a client terminal device and a website. For purposes of explaining the present invention, an auction site transaction is used in the exemplary embodiment although it is understood that the present invention is applicable to any of many other types of electronic transactions (such as simple sales transactions) which occur between a client and a remote server site. There are currently many auction sites established and accessible on the World Wide Web and there are many kinds of auctions that are offered. In the present example, a so-called “Yankee Auction” format will be referenced. In the Yankee Auction, several identical items are offered for sale at the same time. When the auction is completed, the highest bidders win the auctioned item at their respective bid price. If there are ten items for example, the ten highest bidders win the item at the price input by the respective bidders. The term “item” as used herein means either a product or a service, and the term “purchase” as used herein also includes the purchase or license of a hardware or software product.

In the present example, after a client has set the audio preferences (FIG. 3), the client will log on to an auction site (e.g. “AUCTIONSITE.COM” 307) and the auction processing will begin. Initially, the client or user will “register” by providing requested information including the account to be charged for any items purchased. After that information has been entered, the client is then able to view various items that are being offered at the auction. The user then, for example, selects the item for which the user wishes to bid and enters a particular bid. The user then generally exits the auction website. Typically, in the past, at a designated time, the auction is declared over and if the user's bid is a winning bid, the user is generally advised of that situation by email. If the user's bid is not a winning bid, then no notice is given to the user and the user must log on to the auction site again to find out what the winning bids were.

The present invention provides a methodology by which the user is alerted and advised directly when the entered bid is no longer a winning bid (i.e. another bidder had entered a higher bid) and this allows the user to re-enter the auction site to place a new bid before the auction is completed. This is accomplished through code on the server which is effective, in connection with the bidding process, to establish or initialize a new direct alert port (separate from the port being used for the initial registration) between the auction site and the user terminal for the transmission of messages from the auction site server to the user terminal. The server code compares the user's bid with subsequent received bids, and when the user's bid is no longer winning, the server sends a message to the user terminal over the assigned separate port to sound the user-selected audio alert scenario. When the user hears the alert, the user knows that the user's bid is no longer winning. At that time the user may return to the auction site to enter a new bid.

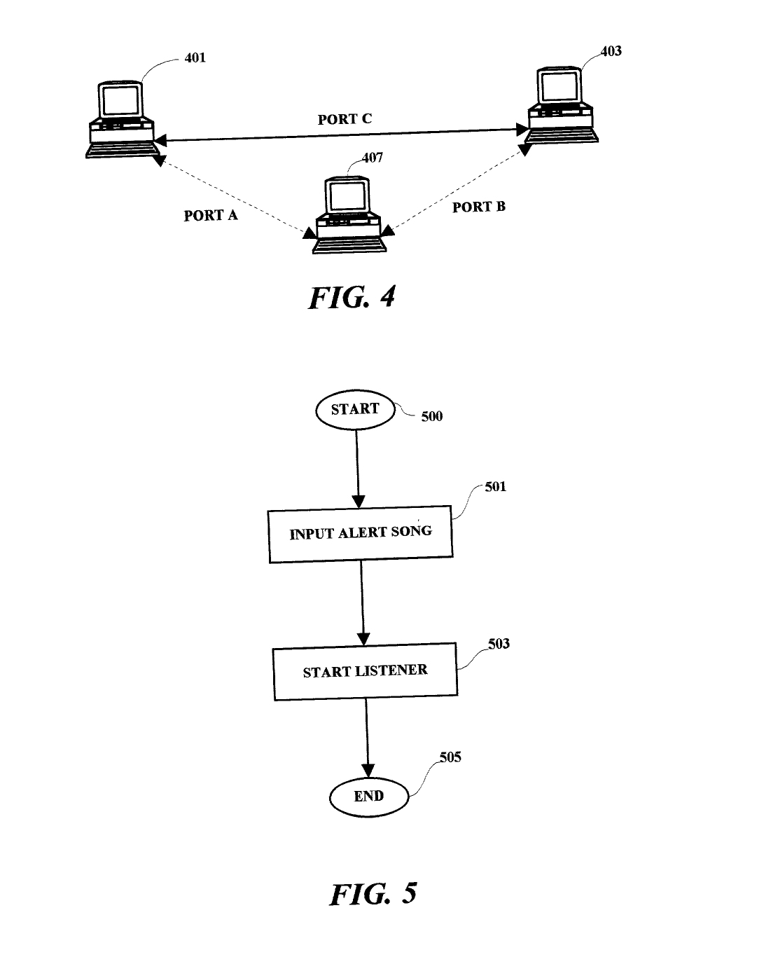

The initialization or establishment of a new and separate alert port by the server for the alert message is illustrated in FIG. 4. Typically, in the past, messages from a server to a user device have been sent by email, for example, from a server 401 to a user terminal or device 403 through an email server 407. As illustrated, the email is sent by the server 401 through one port “A” to the email server 407 and then the email is transmitted through another port “B” to the user terminal 403. The establishment and use of a new and separate port “C” between the auction server 401 and the user terminal 403 bypasses much processing in the email server and allows much faster delivery of transaction status messages to the user. In the present example, port #4003 was selected as port “C” to send alert messages from an auction server to a user device.

As shown in FIG. 5, the high level methodology begins 500 by inputting the alert song 501. The alert song includes the selections made by the user in establishing the user's preferences (tones, length, frequency and duration) for the alert signal when it is received from the auction server. Next the Listener is started 503, and the user device is enabled to “listen for” or detect messages coming in at the user device on the separate alert port (e.g. port #4003 in the present example) established by the auction site server and the initialization ends 505. The “listener” or client-side code is then enabled to process alert messages to the listener at the user device via the separate alert port established by the auction server.

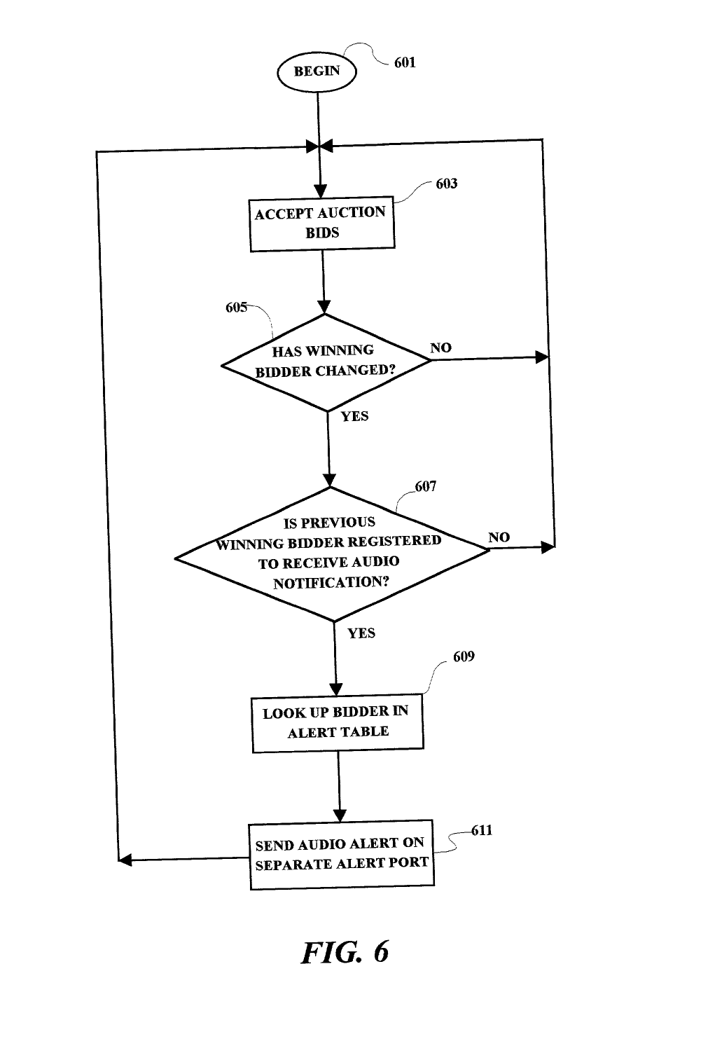

The exemplary methodology executed at the auction server is shown in FIG. 6. As illustrated, after the process begins 601, the server accepts auction bids 603 from clients. When a client bid is received, a check is made to determine if the previous winning bidder has changed 605 because of the newly received bid. If the winning bidder has not changed 605 then the process returns to accept subsequent bids. It is understood that in the event of a so-called “Yankee Auction”, this step will determine if any, and how many previous winning bids are rendered “no longer winning” by new bids received. If the previous winning bidder has changed 605, a check is then made to determine if the previous winning bidder is registered to receive an audio notification 607. If the previous winning bidder has not been registered to receive audio notification 607, then the processing returns to continue to receive new bids 603. If the previous winning bidder is registered to receive notice 607, then the previous bidder who no longer has a winning bid is looked-up in an “alert table” 609 for example, and an audio alert signal is sent from the auction server site to the client bidder on a separate alert port 611 (i.e. separate from the port on which the bids are received) which has been established for this purpose. The auction server then returns to accept subsequent auction bids 603.

An example of pseudocode which could be used to implement the methodology set forth in FIG. 6, for server-side message processing after bidder change, is set forth below:

Function AlertGenerate(szUserAddress As String, szBidderIdent,intTimeout As Integer,
strItem# As String)
‘--- Initialize Function Parameters

Dim EndTime As Date
String strALERT = “AUDIO”
Int intPort = 4003

‘--- Connect to Client on Audio Alert Port

If SocketConnect(winSocket1,4003,szUserAddress,intTimeout) =0
EndTime = DateAdd(“s”,intTimeOut,Now)
‘--- Wait for Client to Acknowlege Connection or TimeOut

Do

Do Events

If NOW > EndTime Then Exit Do

Loop Until BoolClientReady()

```
‘--- Client has responded with a ready indication Send Alert
If BoolClientReady Then
  SendData winSocket1,intPort, strALERT Code & strItem# & szBidderIdent
  Close winSocket1
Return
Function BoolClientReady()
‘This function is called when response data is received from the client; it assumes that
an response indicates that the client is ready. A more elaborate protocol could be
established here
Return True
```

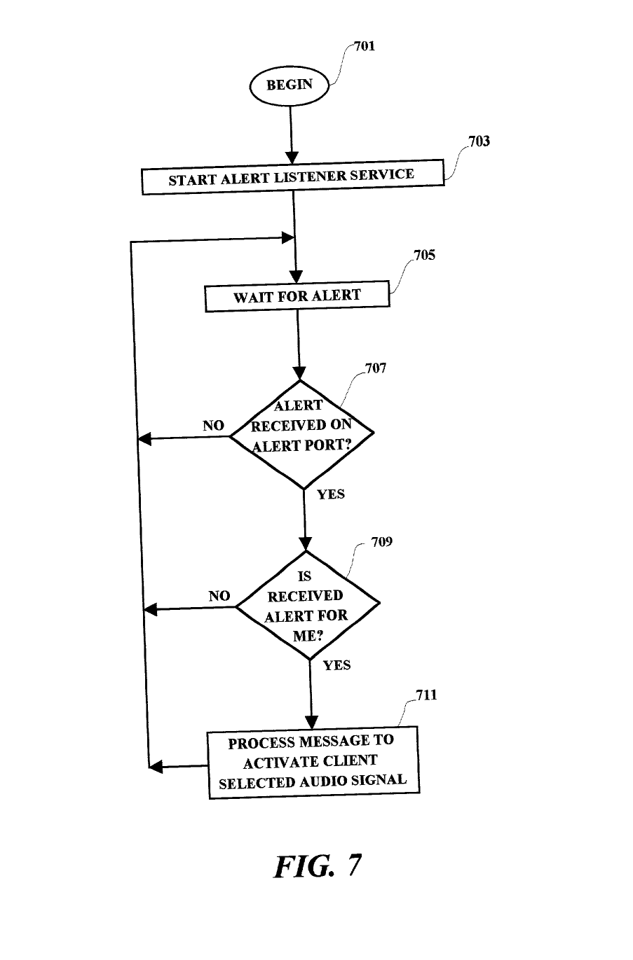

The exemplary user or client terminal methodology is illustrated in FIG. 7. As shown, when the processing begins 701 the listener service is started 703 and the listener function at the user terminal waits for an alert message 705 from the auction server through the special message port (e.g. Port #4003) established by the server. If the message is not received over the alert port, the process returns to await the next received alert 705. When a message is received over the designated alert port 707, a check is made to determine if the alert is intended for the client terminal 709 and if so, the message is processed to activate the client-selected audio alert scheme 711, i.e. the alert selections made in FIG. 3 are executed.

An example of pseudocode which could be used to implement the methodology set forth in FIG. 7, for client side audio message initialization, for continuing listening, is set forth below:

Function AlertInitialize(szHostAddress, szUserName, szPassword)
‘--- Init Occurs to Initialize or Start Client Audio Alert Processing

| Dim EndTime As Date | |
|---|---|
| Int intPort = 4003 | |
| Integer intTimeOut = 60 | ‘assime a 60 second timeout value |

‘--- Get predefined Uadio String

Open (szaudioFile) for Input
Read AudioData into szAudio

‘--- Connect to Auction and Listen for ALERTs

If SocketConnect(dsSocket1,4003,szHostAddress,intTimeout) =0
EndTime = DateAdd(“s”,intTimeOut,Now)

```
  ‘--- Wait for Host to Acknowlege Connection or TimeOut
  Do
```

Do Events

If NOW > EndTime Then Exit Do
BoolHostRead= conReady()

Loop Until boolHostReady

```
  ‘--- Host has responded with a ready indication Send User id & Password so HOST
  knows you are legitimate
  If BoolHostReady() Then
```

SendData dsSocket1, szUsername, szPassword
BoolHostReady = False

```
  ELSE
  POST HOST NOT Responding message
Return
Function conReady(()
‘This function is called when response data is received from the client; it assumes that
an response indicates that the client is ready. A more elaborate protocol could be
established here
  return True
An example of pseudocode which could be used for client side
alert receipt processing is set forth below:
Function AlertReceipt(szHostAddress, szAlertString)
  ‘--- Init Occurs to Initialize or Start Client Audio Alert Processing
```

| Dim End Time As Date | |
|---|---|
| Int intPort = 4003 | |
| Integer intTimeOut = 60 | ‘assime a 60 second timeout value |

String SzReady = “Ready”

‘--- Wait for a Receive Event
Do

Do Events
Loop Until boolHostReady

‘--- Host has responded with a request for connection Send Acknowledgement (protocl
checking could be included)

SendData winSocket1, intPort, szReady
‘--- Wait for a Receive Event

Do

Do Events

BoolHostReady=conReady()

Loop Until boolHostReady

| | |
|---|---|
| Process_Alert_String(szAlertString) | ‘Produce Tones Based on User Pref. |
| Function conReady(() | |

‘This function is called when response data is received from the client; it assumes that
an response indicates that the client is ready. A more elaborate protocol could be
established here
return True

An exemplary XML (eXtended Markup Language) record of the alert audio effect to be produced at the client device is set forth below:

<song tempo = 100>

<measure>

<note> A 1 </note>
<note> C 2 </note>

<measure>

</song>

The above code specifies that, in the example, the audio to be played is the note “A” for 1 beat, followed by the note “C” for 2 beats. As indicated in the flowcharts, this must be done prior to starting the client side processing.

As noted earlier, although the exemplary embodiment illustrates an auction transaction, the disclosed methodology is also applicable to many other electronic transactions which have follow-up aspects to it. For example, the methodology may be implemented to send credit approval or disapproval information to a bidder, or in a straight sales transaction, delivery date or other current shipment or delay information may be sent to a buyer by means of a separately set up message communication port. The audio alert aspect of the present invention is especially useful in situations where the user enters a bid and then continues “surfing” at other sites on the web, or where the bid is entered with a hand-held device which is pocketed after the entry of the bid. In both cases, the audio alert will alert the user who may not be paying particular attention to the auction site for developments. Further, it is noted that the alert may be in the form of an audio voice byte with a predetermined message. For example, the audio alert scheme may be selected to sound two tone sounds followed by a playback of a voice recording stating that “Your bid is no longer a winning bid”. In one embodiment, the recorded message may be one created or dictated by the user into the communication device at the time the bid is entered. Further, separate ports may be created for separate items which are bid upon, and the ports can be tied into custom recordings. In that case, separate messages may result in separate play-backs, one stating that “Your bid for the 25 inch television is no longer a winning bid” and another stating that “Your bid for the DVD player is no longer a winning bid”.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely in program code stored on a CD or diskette or other memory device, from which it may be accessed and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing electronic transactions, said method comprising:
receiving input by a server terminal from a client device over a first communication port to initiate an electronic transaction;
establishing a second communication port for directly coupling said server terminal to said client device; and
transferring information regarding said electronic transaction from said server terminal to said client device over said second communication port.

2. The method as set forth in claim 1 and further including:
detecting receipt of said transaction information by said client device; and
providing an audio effect by said client device upon detection of receipt of said transaction information.

3. The method as set forth in claim 2 wherein said audio effect comprises an alert signal effective to alert a client that said transaction information has been received, said client device further including client input means arranged for enabling a client to select characteristics of said audio effect.

4. The method as set forth in claim 3 wherein said input means is effective to enable said client to select one or more tones as said alert signal.

5. The method as set forth in claim 3 wherein said input means is effective to enable said client to select a predetermined voice message as said alert signal.

6. The method as set forth in claim 5 wherein, in addition to said predetermined voice message, said input means is effective to enable said client to select from a number of audio signals to comprise said alert signal.

7. The method as set forth in claim 1 wherein said electronic transaction comprises a purchase of an item by a client using said client device.

8. The method as set forth in claim 1 wherein said electronic transaction comprises an auction transaction wherein bids for an item being auctioned are sent by said client device and received by said server terminal, said server terminal being operable for:
receiving bids for said item by said server terminal;
determining when a previously received bid is no longer a winning bid; and
sending notice that said previously received bid is no longer a winning bid, said notice comprising said transaction information sent over said second communication port.

9. The method as set forth in claim 1 wherein said client device is a computer system connected to said server terminal.

10. The method as set forth in claim 1 wherein said client device is a wireless device.

11. The method as set forth in claim 10 wherein said wireless device is a cellular device.

12. The method as set forth in claim 10 wherein said wireless device is a portable device.

13. A system for processing electronic transactions, said system comprising:
a server terminal;
a client device; and
means arranged for selectively connecting said client device to said server terminal, said server terminal being selectively operable for:
receiving input by said server terminal from said client device over a first communication port to initiate an electronic transaction;
establishing a second communication port for directly coupling said server terminal to said client device; and
transferring information regarding said electronic transaction from said server terminal to said client device over said second communication port.

14. The system as set forth in claim 13 wherein said client device is selectively operable for:
detecting receipt of said transaction information from said server terminal; and
providing an audio effect upon detection of receipt of said transaction information.

15. The system as set forth in claim 14 wherein said audio effect comprises an alert signal effective to alert a client that said transaction information has been received, said client device further including client input means arranged for enabling a client to select characteristics of said audio effect.

16. The system as set forth in claim 15 wherein said input means is effective to enable said client to select one or more tones as said alert signal.

17. The system as set forth in claim 15 wherein said input means is effective to enable said client to select a predetermined voice message as said alert signal.

18. The system as set forth in claim 17 wherein, in addition to said predetermined voice message, said input means is effective to enable said client to select from a number of audio signals to comprise said alert signal.

19. The system as set forth in claim 13 wherein said electronic transaction comprises a purchase of an item by a client using said client device.

20. The system as set forth in claim 13 wherein said electronic transaction comprises an auction transaction wherein bids for an item being auctioned are sent by said client device and received by said server terminal, said server terminal being operable for:
receiving bids for said item by said server terminal;
determining when a previously received bid is no longer a winning bid; and
sending notice that said previously received bid is no longer a winning bid, said notice comprising said transaction information sent over said second communication port.

21. The system as set forth in claim 13 wherein said client device is a computer system connected to said server terminal.

22. The system as set forth in claim 13 wherein said client device is a wireless device.

23. The system as set forth in claim 22 wherein said wireless device is a cellular device.

24. The system as set forth in claim 22 wherein said wireless device is a portable device.

25. A server terminal arranged for processing electronic transactions, said server terminal comprising:
means for receiving input from a client device over a first communication port to initiate an electronic transaction;
means for establishing a second communication port for directly coupling said server terminal to said client device; and
means for transferring information regarding said electronic transaction from said server terminal to said client device over said second communication port.

26. A client device for participating in an electronic transaction, said client device comprising:
input means selectively operable for inputting client-related transaction information relevant to said electronic transaction;
means for transmitting said client-related transaction information to a server terminal over a first port, said server terminal being operable in response to said client-related transaction information for establishing a second port selectively operable for sending server-related transaction information to said client device; and
means for selectively receiving said server-related transaction information from said server terminal over said second port.

27. The client device as set forth in claim 26 and further including audio means operable to produce an audio effect in response to receipt of said server-related transaction information.

28. A storage medium including machine readable coded indicia, said machine readable coded indicia being selectively operable when executed within a computer system for accomplishing the steps of:
receiving input by a server terminal from a client device over a first communication port to initiate an electronic transaction;
establishing a second communication port for directly coupling said server terminal to said client device; and
transferring information regarding said electronic transaction from said server terminal to said client device over said second communication port.
